(19) United States
(12) Patent Application Publication
(10) Pub. No.: US 2026/0340097 A1
(43) Pub. Date: Oct. 29, 2026

(54) System and Method for Verifying Voice Samples from Participants of an Audio Communication Session using a Real-Time Acoustic Authentication Protocol

(71) Applicant: Gilberto Antonio Perez Zorrilla, La Romana (DO)

(72) Inventor: Gilberto Antonio Perez Zorrilla, La Romana (DO)

(21) Appl. No.: 19/661,338

(22) Filed: Apr. 28, 2026

Related U.S. Application Data
(60) Provisional application No. 63/796,047, filed on Apr. 28, 2025.

(51) Int. Cl. G06F 21/32; G10L 17/02; G10L 17/04; G10L 17/06

(52) U.S. Cl. CPC G06F 21/32; G10L 17/02; G10L 17/04; G10L 17/06

(57) ABSTRACT

A system and method for verifying voice samples from participants of an audio communication session using a real-time acoustic authentication protocol are used to authenticate session participants through dynamic multi-parameter analysis. A communication session is established between participant accounts. A voice sample is captured from each of the participant accounts using the corresponding communication device of each participant account. The captured voice sample of each of the participant accounts is relayed from the corresponding communication device of each participant account to a remote server. The voice sample of each of the participant accounts is authenticated based on the user voiceprint of each participant account. An authenticity certificate is generated, if each voice sample of the participant accounts is authenticated. The authenticity certificate is relayed from the remote server to the corresponding communication device of each of the participant accounts. Several iterations are periodically performed while the communication session remains active.

### FIELD OF THE INVENTION

The present invention relates generally to audio communication protocols and data security systems. More specifically, the present invention provides a real-time acoustic authentication protocol designed to verify voice samples from the participants of an audio communication session to ensure the security of audio communication sessions, such as voice calls.

### BACKGROUND OF THE INVENTION

Caller Identification (ID) authentication is a growing challenge in the field of cybersecurity. As phone-based crimes and fraud evolve, robust authentication methods are required to validate the identity of call participants to reduce the significant risks consumers and businesses face. Vulnerabilities in caller authentication have increased due to the rise in cloned voices generated using Artificial Intelligence (AI). By training an AI-based Private Branch Exchange (PBX) system with voices from well-known institutions and leaked user data, highly effective phishing attacks can be conducted. These phishing attacks exploit the lack of authentication mechanisms to impersonate voices with high accuracy, deceiving users through a virtual assistant that appears legitimate. Therefore, novel means are necessary to authenticate caller ID in real time that minimizes the risk of impersonation by verifying the acoustic authenticity of the caller's voice.

To address these issues, the present invention provides novel means for verifying voice samples from participants of an audio communication session using a real-time acoustic authentication protocol. The protocol of the present invention, preferably referred to as Call Verify Secure Protocol (CVSP), utilizes voice parameters instead of the audio from the audio communication session to authenticate the voice samples of the participants in real time. By enabling continuous authentication and visual verification, the present invention addresses the demand for greater security in communications for both private companies and government organizations. Additional features and benefits of the present invention are further discussed in the sections below.

### SUMMARY OF THE INVENTION

The present invention discloses a system and method for verifying voice samples from participants of an audio communication session using a real-time acoustic authentication protocol. The protocol of the present invention, preferably referred to as Call Verify Secure Protocol (CVSP), is designed to ensure the security of audio communication sessions, such as voice calls, for all participants. The CVSP of the present invention is a protocol-level authentication mechanism applicable to general communication sessions over a wide range of communication technologies. In response to the growing need for traceability and reliable caller authentication, the present invention provides means to verify the caller identity within the first few seconds of the call without the need to record call audio. This is especially important in contexts like call centers, commerce, and financial services where the trust in knowing the identities of call participants is essential. So, the present invention serves as a parametric, certificate-based authentication mechanism that does not require direct biometric identity recognition of the call participants.

In the preferred embodiment, the CVSP of the present invention analyzes the caller's acoustic parameters to generate an “acoustic certificate” that reinforces trust in the audio communication session. The CVSP of the present invention operates similarly to the Secure Sockets Layer (SSL) and Transport Layer Security (TLS) protocols. This way, the present invention can offer secure authentication for communications by serving as a powerful tool to prevent fraud and support criminal investigations. The present invention can be tailored to meet the specific requirements of real-time acoustic validation, communication services, etc. Further, the present invention can be implemented over different communication technologies including, but not limited to, Voice Over Internet Protocol (VoIP) systems, audio-enabled platforms, distributed communication systems, and Internet of Things (IoT) environments.

### BRIEF DESCRIPTION OF THE DRAWINGS

FIG. 1 is a box diagram illustrating the overall system of the present invention.

FIG. 2 is a box diagram illustrating the overall method of the present invention.

FIG. 3 is a schematic showing the user interface of a communication device of the system of the present invention, wherein the communication device is shown with a visual closed lock to notify the user of a secure audio communication session.

FIG. 4 is a flowchart illustrating the overall process of the method of the present invention.

FIG. 5 is a flowchart illustrating a continuation of the overall process of the method of the present invention shown in FIG. 4.

FIG. 6 is a flowchart illustrating the subprocess of establishing an audio communication session with the system of the present invention.

FIG. 7 is a flowchart illustrating the subprocess of authenticating the voice sample of each participant account in the audio communication session.

FIG. 8 is a flowchart illustrating the subprocess of taking data noises into consideration during authentication of a voice sample.

FIG. 9 is a flowchart illustrating the subprocess of notifying each participant account that the audio communication session is secure.

FIG. 10 is a flowchart illustrating the subprocess of notifying each participant account that the audio communication session is insecure.

FIG. 11 is a flowchart illustrating the subprocess of establishing the baseline parameters for the initial user voiceprint.

FIG. 12 is a flowchart illustrating the subprocess of updating a user voiceprint during the current audio communication session.

### DETAIL DESCRIPTIONS OF THE INVENTION

All illustrations of the drawings are for the purpose of describing selected versions of the present invention and are not intended to limit the scope of the present invention.

The present invention discloses system and method for verifying voice samples from participants of an audio communication session using a real-time acoustic authentication protocol. The present invention, preferably referred to as the Call Verify Secure Protocol (CVSP), is a network-neutral, entity-neutral authentication framework designed to authenticate the participants'voices through dynamic multi-parameter analysis and cryptographic token generation. Further, the present invention can be implemented into different applications to perform various functions, such as detecting Artificial Intelligence (AI) voice agents on voice calls to ensure the integrity of verification processes in customer service centers and support channels. By analyzing specific acoustic parameters and comparing them to baseline acoustic samples, the present invention can identify variations that suggest manipulation or impersonation. In addition, in high-risk situations, the present invention can implement call traceability to allow authorized users, such as law enforcement, to identify and block malicious automated activities.

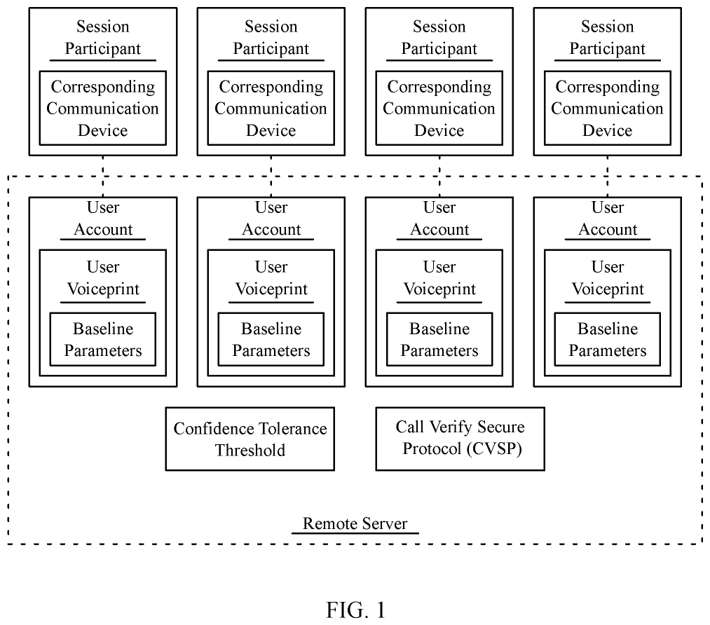

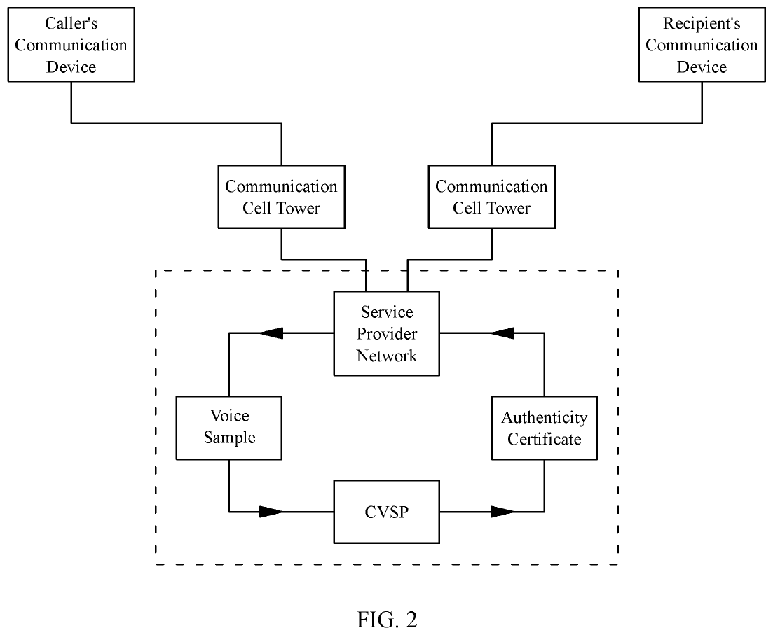

In the preferred embodiment, the system of the present invention is preferably implemented on the architecture of the service provider so that all processes are performed using the computational facilities of the service provider, as can be seen in FIGS. 1 and 2. The service provider can be a communication service provider that provides communication services in a specific geographical area using different communication technologies. This way, the service provider takes care of the implementation of the CVSP of the present invention and provides the communication services to the users who contract the service provider. Alternatively, the CVSP of the present invention can be implemented as a third-party service that is connected to the architecture of the service provider. This way, the service provider can normally provide communication services while the CVSP provides voice authentication services without affecting the service provider architecture.

In general, the system of the present invention includes a plurality of user accounts managed by at least one remote server (Step A). Each user account can be set up by the service provider when gaining access to the services of the service provided. Alternatively, each user account can be created independent from the service provider by the system of the present invention. Further, the remote server can be part of the service provider architecture or implemented as an independent system that is connected to the service provider architecture. For example, the processes of the system can be centralized so all are performed on a single server. Several servers may also be implemented, each performing specific processes of the system.

Further, each user account is associated with a corresponding communication device that gives the user access to the communication services of the service provider. For example, the corresponding communication device can be a smartphone, tablet computer, laptop, or any other electronic device that allows the user to have an audio communication session using the services of the service provider. Moreover, each user account from the plurality of user accounts includes a user voiceprint managed by the remote server (Step B), as can be seen in FIGS. 1 and 2. The user voiceprint is a digital record of the corresponding user's voice that can be used to verify the identity of the user during an active audio communication session. The system of the present invention prioritizes privacy by avoiding the storage of full voice recordings. Therefore, the user voiceprint does not contain information about the user's voice but rather characteristics that help verify authenticity without exposing sensitive user data.

By implementing a robust framework for real-time authentication, the present invention not only enhances the security of communications but also optimizes the user experience by reducing false positives and ensuring that only legitimate interactions are validated. In an environment where cybercrime constantly evolves, the CVSP's ability to adapt and respond to emerging threats is crucial to maintaining trust in digital communication systems. Further, the CVSP is equipped with machine learning and AI capabilities to update the user voiceprint without compromising user privacy or directly storing user-identifiable data. This approach ensures high security and privacy by complying with data protection standards, thus mitigating exposure risks in case of intrusions or unauthorized access attempts to the remote server.

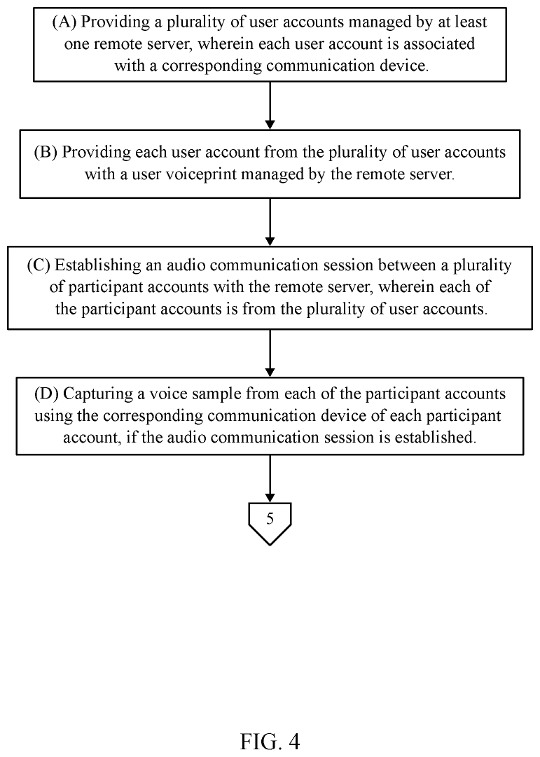

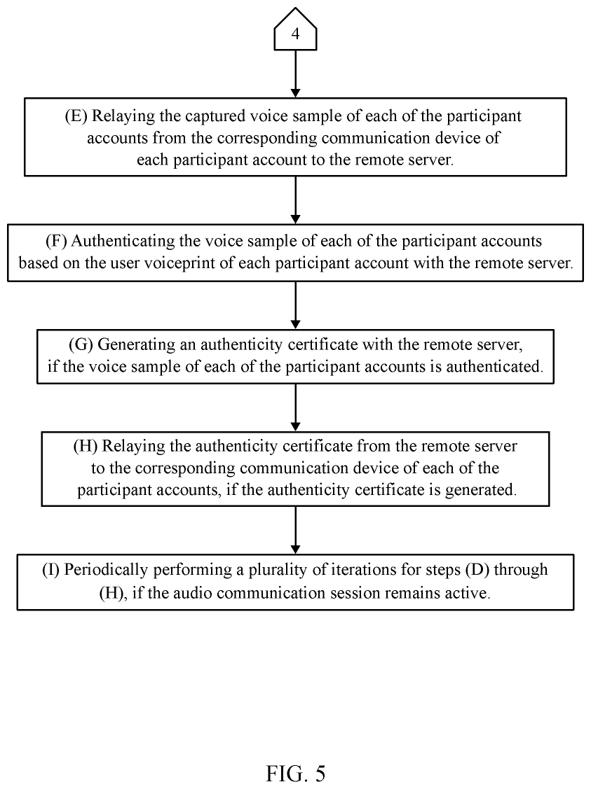

The system of the present invention allows the implementation of a method that automatically verifies the identity of the participants of an audio communication session to ensure each participant that the audio communication session is secure and that the identity of the other call participants has been authenticated. As can be seen in FIGS. 4 and 5, the overall process of the method of the present invention begins by establishing an audio communication session between a plurality of participant accounts with the remote server (Step C). The plurality of participant accounts corresponds to users of the service provider that participate in the current audio communication session, and each user utilizes the corresponding communication device to join the audio communication session. If the audio communication session is established, a voice sample from each of the participant accounts is captured using the corresponding communication device of each participant account (Step D). The voice sample of each participant account is briefly captured during the audio communication session using the device's integral microphone or other audio-capturing device.

As can be seen in FIGS. 4 and 5, the captured voice sample of each of the participant accounts is relayed from the corresponding communication device of each participant account to the remote server (Step E). The voice sample from each of the participant accounts is necessary to ensure the security of the audio communication session to every user who is participating in the audio communication session. Then, the voice sample of each of the participant accounts is authenticated based on the user voiceprint of each participant account with the remote server (Step F). Different authentication methods can be implemented such as device-level parameter extraction, server-side validation, hybrid validation models, and optional offline local verification. If the voice sample of each of the participant accounts is authenticated, an authenticity certificate is generated with the remote server (Step G). Every participant account needs to be verified to ensure the security of the audio communication session for all the participant accounts.

As can be seen in FIGS. 4 and 5, if the authenticity certificate is generated, the authenticity certificate is relayed from the remote server to the corresponding communication device of each of the participant accounts (Step H). The authenticity certificate is shared between the participant accounts so that every participant account is ensured that the audio communication session is secure. Further, a plurality of iterations for Steps D through H is periodically performed (Step I), if the audio communication session remains active. In other words, the overall process is repeated periodically while the audio communication session is active to ensure the participant accounts that the audio communication session is secure throughout the duration of the audio communication session. For example, an initial authentication can be performed at the beginning of the audio communication session, and subsequent authentications can be performed at predetermined intervals while the audio communication session is active. For example, the subsequent authentications can be performed every 30 seconds while the audio communication session is active. The length of the intervals are preset by the system administrators. In other embodiments, the method of the present invention can be altered to accommodate other voice authentication protocols.

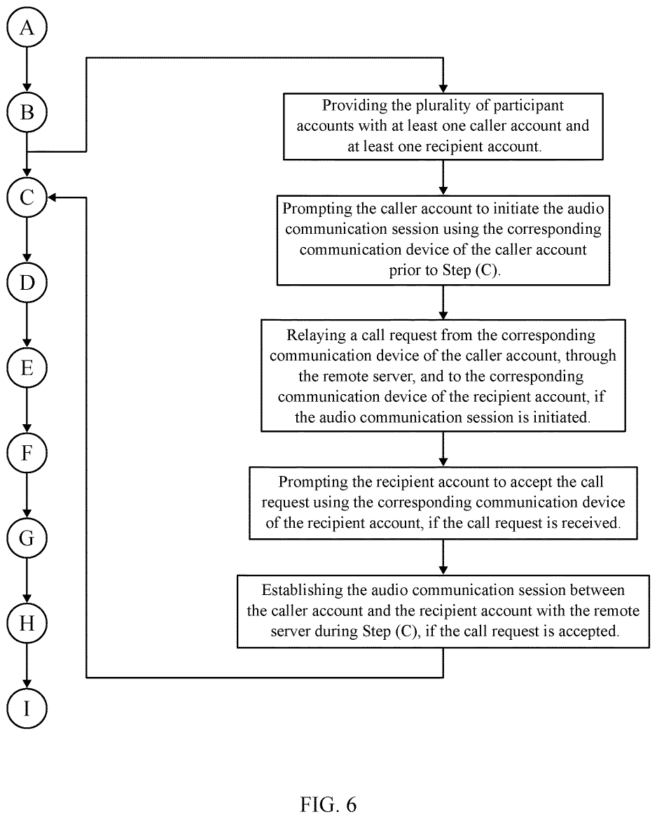

As can be seen in FIGS. 1 through 3, the audio communication session can be established using the architecture of the service provider in a manner that is commonly done in traditional communication services. In the preferred embodiment, an audio communication session in the system of the present invention can be established with at least one caller account and at least one recipient account from the plurality of participant accounts. The caller account is the user account who initiates the audio communication session, while the recipient account is the user account who receives the audio communication session. As can be seen in FIG. 6, the subprocess of establishing an audio communication session includes the steps of prompting the caller account to initiate the audio communication session using the corresponding communication device of the caller account prior to Step C. The caller can initiate the audio communication session normally using the user interface of the corresponding communication device. If the audio communication session is initiated, a call request is relayed from the corresponding communication device of the caller account, through the remote server, and to the corresponding communication device of the recipient account.

As can be seen in FIG. 6, the call request is relayed via the service provider's architecture as normal or through different communication services accordingly. Once the call request is received by the recipient, the recipient account is prompted to accept the call request using the corresponding communication device of the recipient account. The normal notification methods implemented on the corresponding communication device can be utilized to notify and prompt the recipient to accept the call request. Then, the audio communication session is established between the caller account and the recipient account during Step C, if the call request is accepted by the recipient. Thus, the present invention can operate normally without altering the current way the service provider's users make and receive calls. In other embodiments, the CVSP of the present invention can be altered to accommodate different communication protocols.

As previously discussed, the voice of each participant account is analyzed by the system of the present invention while the audio communication session is active using previously established user voiceprints stored in the remote server. As can be seen in FIGS. 1 through 3, each user voiceprint is provided with a plurality of baseline parameters that form the digital voiceprint of each user of the service provider. Each baseline parameter corresponds to an established acoustic feature parameter of the user voiceprint. In the preferred embodiment, the baseline parameters of each user voiceprint can include different acoustic parameters that are used to model the corresponding user voiceprint. The user voiceprint is implemented as a Verifiable Acoustic Record (VAR) that contains specific acoustic parameters that enable real-time authenticity verification. The acoustic parameters used for the user voiceprint preferably include, but are not limited to, audio energy, average silence duration, average spectral entropy, voice pitch, voice formants, voice intensity, frequency variability, voice prosody, jitter and shimmer, voicing and breathiness, timbre, Mel-Frequency Cepstral Coefficients (MFCC), etc. Alternate acoustic parameters may be implemented as necessary.

The voice energy corresponds to a measurement of the total energy of the audio, indicating signal intensity. The average silence duration corresponds to the average time without sound activity. The average spectral entropy corresponds to a measurement that indicates the complexity and variability of the signal's spectrum. The voice pitch corresponds to the fundamental frequency of the signal, important for voice identification. The voice formants, specifically the F1, F2, F3, and F4 formants, correspond to resonant frequencies that characterize the voice's timbre. Further, the voice intensity corresponds to the measurement of the signal's average Root Mean Square (RMS) energy. The frequency variability corresponds to the measurement of the dispersion of frequencies in the signal. The voice prosody corresponds to the measurement that captures frequency variability over time. Jitter and shimmer are indicators of period and amplitude variability, respectively. Moreover, voicing and breathiness corresponds to measurement of specific voice characteristics. Timbre is a measurement that reflects the tonal quality of the signal. Furthermore, MFCC is a measurement that represents the spectral envelope of the signal, useful for characterizing voice quality.

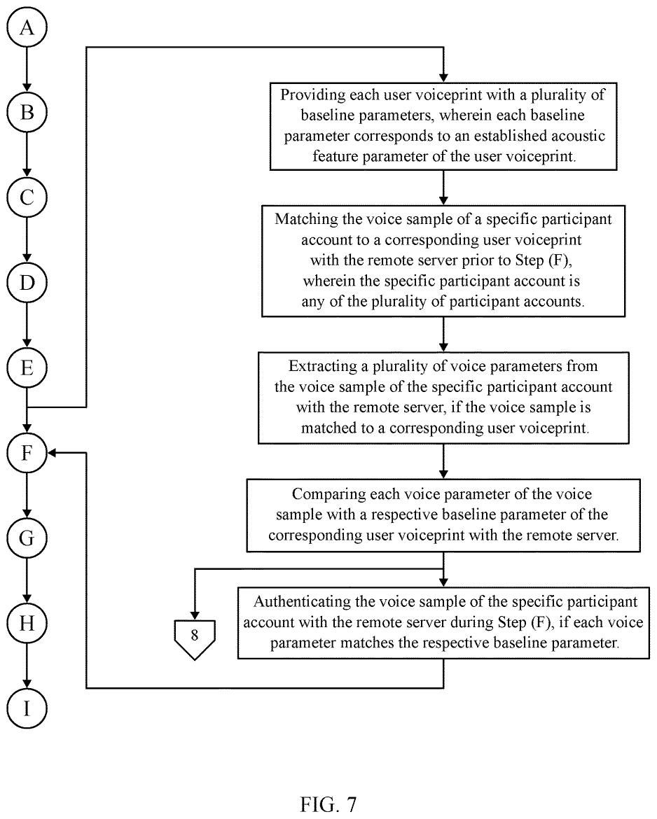

As can be seen in FIG. 7, the subprocess of authenticating the voice sample of each participant account includes the steps of matching the voice sample of a specific participant account to a corresponding user voiceprint with the remote server prior to Step F. The specific participant account is any of the participant accounts of the current audio communication session that is authenticated by the system of the present invention. Once the corresponding user voiceprint for the specific participant is determined, a plurality of voice parameters is extracted from the voice sample of the specific participant account with the remote server. The specific voice parameters extracted depend on the acoustic parameters used for the user voiceprint of the specific participant account. Then, each voice parameter of the voice sample is compared with a respective baseline parameter of the corresponding user voiceprint with the remote server. For example, the extracted voice timbre would be compared with the recorded voice timbre of the user voiceprint. Finally, the voice sample of the specific participant account is authenticated with the remote server during Step F, if each voice parameter matches the respective baseline parameter. This subprocess is performed for each participant account simultaneously to ensure the security of the current audio communication session.

As previously discussed, the system of the present invention is equipped with machine learning and AI capabilities that allow the implementation of the CVSP with a dynamic weighting engine capable of adjusting acoustic parameter influence based on contextual variance. As can be seen in FIGS. 1 through 3, the system of the present invention may further include a confidence tolerance threshold managed by the remove server. The confidence tolerance threshold is a predetermined measurement used to calculate the tolerable variance of the voice samples captured during the audio communication session. The tolerable variance takes into consideration potential data noise that could result in valid voice samples not being authenticated due to environmental factors. For example, a user may be talking in a noisy environment, may be sick, the communication service may have interferences, etc.

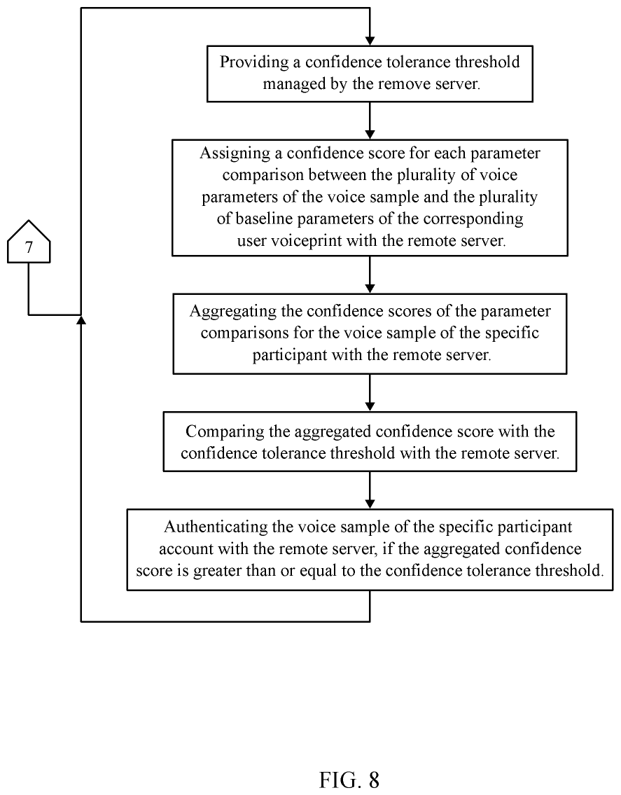

As can be seen in FIG. 8, the subprocess of taking data noises into consideration during authentication of a voice sample includes the steps of assigning a confidence score for each parameter comparison between the plurality of voice parameters of the voice sample and the plurality of baseline parameters of the corresponding user voiceprint with the remote server. The confidence score is a value calculated by the remote server using different methods that represents how accurate the comparison between a voice parameter and the respective baseline parameter is. This takes into consideration potential data noise that could affect the comparison and eventually the authentication of the voice sample of the specific participant account. For example, the comparison between the extracted voice timbre from the voice sample and the recorded voice timbre from the user voiceprint can be assigned a high confidence score even if the corresponding user sounds off due to sickness.

Once confidence scores for each parameter comparison is calculated, the confidence scores of the parameter comparisons for the voice sample of the specific participant are aggregated with the remote server, as can be seen in FIG. 8. The aggregated confidence score may be averaged, totaled, or processed in different manners to match the format of the confidence tolerance threshold. Then, the aggregated confidence score is compared with the confidence tolerance threshold with the remote server to determine if the aggregated confidence score meets the predetermined tolerance threshold. Finally, the voice sample of the specific participant account is authenticated with the remote server, if the aggregated confidence score is greater than or equal to the confidence tolerance threshold. In other embodiments, different methods can be implemented to take voice variances into consideration when authenticating the voice samples of the call participants.

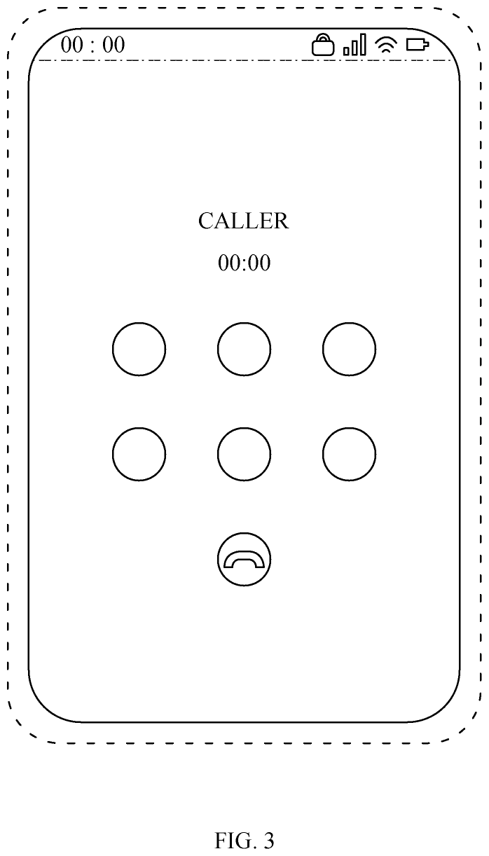

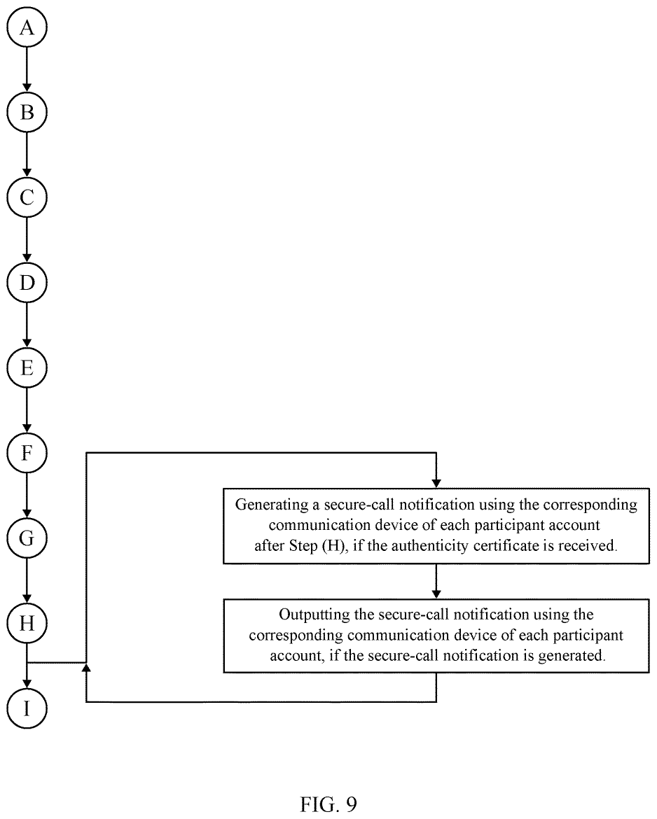

As previously discussed, the authenticity certificate is relayed to each of the participant accounts to ensure each participant account that the audio communication session is secure. As can be seen in FIGS. 3 and 9, the subprocess of notifying each participant account that the audio communication session is secure includes the steps of generating a secure-call notification using the corresponding communication device of each participant account after Step H, if the authenticity certificate is received. The secure-call notification generated can be implemented in different manners depending on the technological capabilities of the corresponding communication device. For example, the secure-call notification can be a visual notification, an audio notification, or any other common notification methods. Further, the secure-call notification is output using the corresponding communication device of each participant account, if the secure-call notification is generated. For example, within the first 10 to 15 seconds after the authenticity certificate is received, a custom tone (distinct for visually impaired users) is output as a sign of successful authentication. In addition, a visual closed lock icon can be displayed by the corresponding communication device to indicate successful authentication. The closed lock icon can be displayed on the user interface, preferably adjacent to the service provider's name on the user interfaces'top bar.

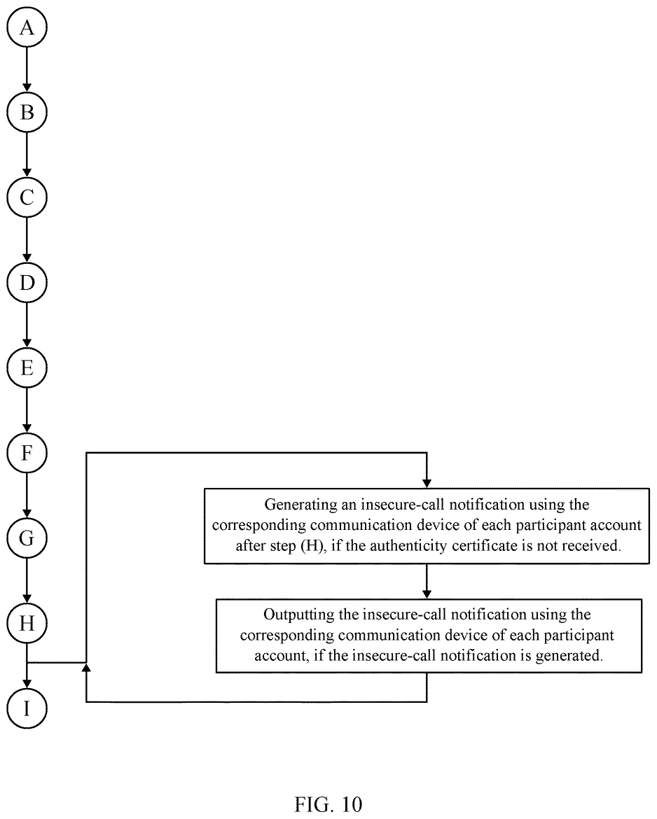

Alternatively, each participant account can also be notified if the authenticity certificate is not received to alert the participant accounts that the audio communication session is insecure. This could mean that one of the call participants was not authenticated and that the other call participants should be cautious of proceeding with the audio communication session. As can be seen in FIGS. 3 and 10, the subprocess of notifying each participant account that the audio communication session is insecure includes the steps of generating an insecure-call notification using the corresponding communication device of each participant account after Step H, if the authenticity certificate is not received. Like the secure-call notification, the insecure-call notification generated can be implemented in different manners depending on the technological capabilities of the corresponding communication device. Further, the insecure-call notification is output using the corresponding communication device of each participant account, if the insecure-call notification is generated. For example, a different custom tone can be output as a sign of unsuccessful authentication to each call participant. In addition, a visual open lock icon can be displayed by the corresponding communication device to indicate unsuccessful authentication. In other embodiments, different audiovisual notifications can be implemented according to other communication device capabilities.

In some embodiments, the authenticity certificate can be as a structured parametric data set capable of cryptographic encapsulation. Different tokenization methods can be implemented to encrypt the data that forms the authenticity certificate. For example, the tokenization method can include hashing, digital signature capability, time-bound validity, and non-reversible parametric encoding. Further, to further validate the identity of the participant accounts of each audio communication session, the system of the present invention may further capture hardware-device identifiers that help track the usage of a corresponding communication device by a user account. For example, the hardware-device identifiers may include, but is not limited to, the device's International Mobile Equipment Identity (IMEI). The device's IMEI can be captured at the same time as the voice sample is captured for authentication.

Further, the captured hardware-device identifiers can be appended into the authenticity certificate to further ensure the participant accounts that the audio communication session is secure. For example, each device IMEI can be used to tokenize the authenticity certificate being relayed to the corresponding communication device. Alternatively, the captured hardware-device identifiers can be stored in the corresponding user accounts for future auditing by authorized users. For example, the service provider may utilize the device IMEI to track the usage of different communication devices by a specific user account. In addition, the device IMEI may be shared with law enforcement agencies as legally required. In other embodiments, different identifiers can be utilized to further ensure the authenticity of the voice sample or the corresponding communication device.

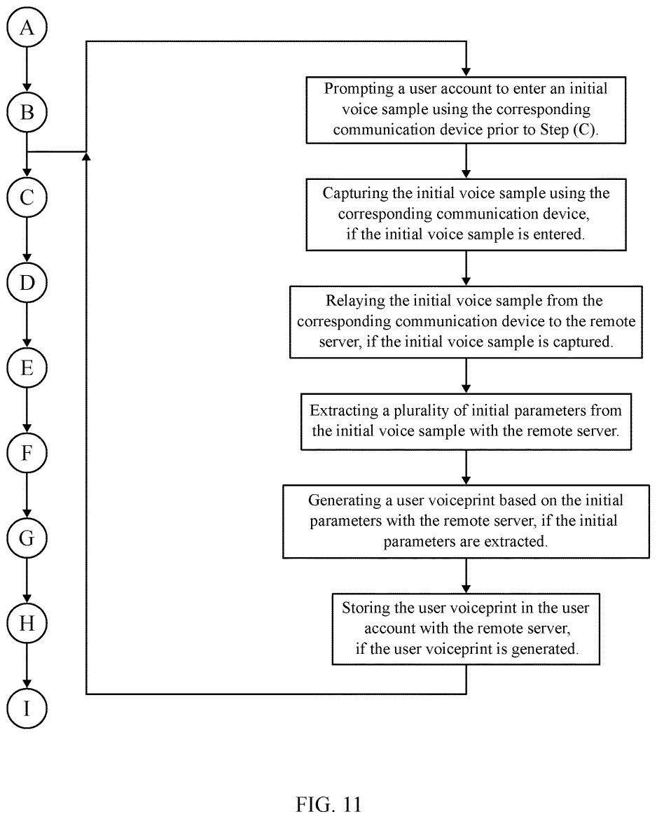

As previously discussed, the user voiceprint is initially established when the user gains access to the communication services of the service provider. As can be seen in FIG. 11, the subprocess of establishing the baseline parameters for the initial user voiceprint includes the steps of prompting a user account to enter an initial voice sample using the corresponding communication device prior to Step C. The initial voice calls performed by the user when acquiring the services of the service provider can be utilized for the initial voice sample. If the initial voice sample is entered, the initial voice sample is captured using the corresponding communication device. Then, the initial voice sample is relayed from the corresponding communication device to the remote server, if the initial voice sample is captured. The initial voice sample can be locally processed at the corresponding communication device, if necessary, before being transmitted to the remote server.

Once the initial voice sample is received by the remote server, a plurality of initial parameters is extracted from the initial voice sample with the remote server, as can be seen in FIG. 11. The initial parameters used for each user voiceprint can be predetermined by administrators for the users of the service provider, and additional voice samples may be requested if not all the required acoustic parameters can be extracted from the initial voice sample. Then, a user voiceprint is generated based on the initial parameters with the remote server, if the initial parameters are extracted. The user voiceprint can be analyzed for quality purposes to ensure that the user voiceprint meets all the acoustic parameters needed for voice authentication. Finally, the user voiceprint is stored in the user account with the remote server, if the user voiceprint is generated, for future voice sample authentications. This way, the system can retrieve the baseline parameters from the user voiceprint for voice authentication every time the corresponding user is identified as a participant account of a current audio communication session.

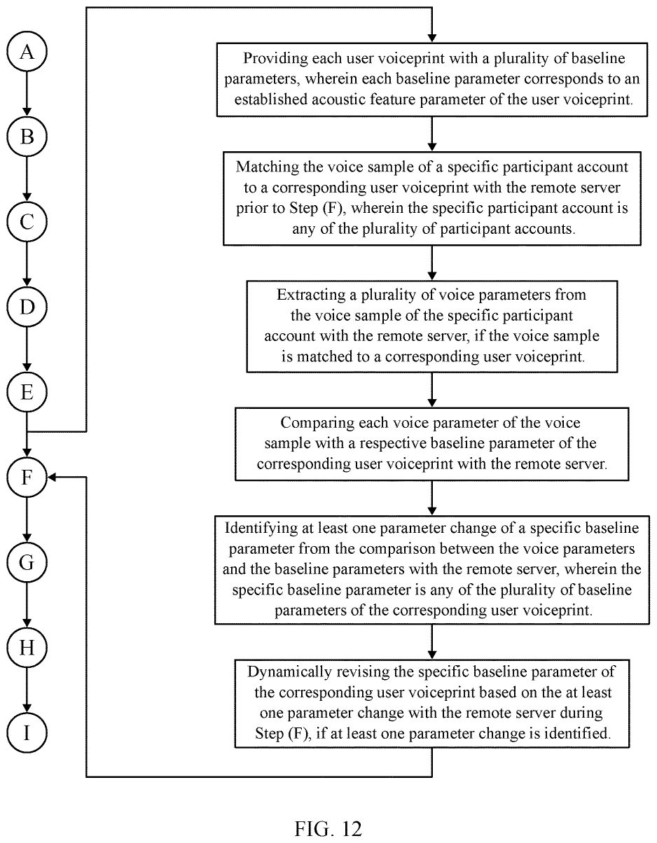

After the user voiceprint is established for a user account, the user voiceprint can be continuously updated to maintain an accurate digital model of the user's voice. With each new call performed by the user, the system of the present invention can adjust and enhance the user voiceprint using machine learning and AI. As can be seen in FIG. 12, the subprocess of updating a user voiceprint during the current audio communication session includes the steps of matching the voice sample of a specific participant to a corresponding user voiceprint with the remote server prior to Step F. Like before, the specific participant account is any of the plurality of participant accounts of the audio communication session currently being authenticated. A plurality of voice parameters is then extracted from the voice sample of the specific participant account with the remote server, if the voice sample is matched to the corresponding user voiceprint of the specific participant account. The same voice parameters used for voice authentication can be used to determine if any of the voices of the participant accounts have changed.

Then, each voice parameter of the voice sample is compared with a respective baseline parameter of the corresponding user voiceprint with the remote server, as can be seen in FIG. 12. For example, the extracted voice timbre would be compared with the recorded voice timbre of the corresponding user voiceprint. This can be performed simultaneously when the voice sample is being authenticated. Further, at least one parameter change of a specific baseline parameter is identified from the comparison between the voice parameters and the baseline parameters with the remote server. In other words, during the comparison between the voice parameters and the baseline parameters of a voice sample, acoustic parameter changes of a specific participant account can be detected by the remote server. The specific baseline parameter can be any of the plurality of baseline parameters of the corresponding user voiceprint, meaning that multiple parameter changes can be detected from the same voice sample of the specific participant account. Then, the specific baseline parameter of the corresponding user voiceprint is dynamically revised based on the at least one parameter change with the remote server during Step F, if at least one parameter change is identified. Multiple parameter changes could also be identified and implemented to update the corresponding user voiceprint. Thus, the user voiceprint of each participant account can be updated during the current audio communication session if necessary.

This subprocess allows the baseline acoustic parameters of the user voiceprint to evolve, maintaining the accuracy and reliability of the user voiceprint regardless of changes to the user's voice and/or environment during future audio communication sessions. As the user continues to perform calls using the services of the service provider, the system of the present invention recognizes patterns and readjusts the baseline parameters of the user voiceprint, minimizing errors and improving the authentication of the voice sample. The system of the present invention ensures real-time authenticity by analyzing each acoustic environment and adapting to natural variations in the user's voice, thus enhancing the CVSP's effectiveness in protecting communications. In other embodiments, different methods powered by machine learning and AI can be implemented to maintain the user voiceprint of each user of the service provider up to date.

### Laboratory Test of the Present Invention

In technical laboratory tests, the CVSP of the present invention has been shown to capture the essence of the user's voice in only 1.1 Kilobytes (kB). This provides a sufficient acoustic representation for authentication of a voice sample without storing a voice recording of the participant account. The system of the present invention enables rapid and efficient data transmission, ideal for systems requiring real-time authentication. Compared to a typical audio file, which was 550.6 kB in Waveform Audio File (WAV) Format with five seconds of recording. Data compression for the voice sample was achieved at 1.1 kB, representing significant optimization and achieving compression of approximately 99.8%.

The compact design of the system of the present invention facilitates CVSP integration in devices and networks with limited resources, while data reduction minimizes privacy risks by avoiding the storage of the complete voice. Additionally, the reduced size ensures scalability, enabling large-scale implementation without overloading networks or compromising response speed in identity verifications. For example, the present invention can be implemented for blockchain identity validation, financial authentication, defense communications, critical infrastructure protection, emergency systems, digital verbal contracts, remote notarization, and forensic parametric traceability. Further. the captured acoustic parameters including, but not limited to, voice energy, average silence duration, average spectral entropy, voice pitch, voice formants (F1, F2, F3, F4), voice intensity, frequency variability, voice prosody, jitter, shimmer, voicing, breathiness, timbre, and MFCCs contribute to achieving precise and reliable identification, enhancing the effectiveness of the authentication system without sacrificing security or signal quality.

Although the invention has been explained in relation to its preferred embodiment, it is to be understood that many other possible modifications and variations can be made without departing from the spirit and scope of the invention.

What is claimed is:

1. A method for verifying voice samples from participants of an audio communication session using a real-time acoustic authentication protocol, the method comprising the steps of:
(A) providing a plurality of user accounts managed by at least one remote server, wherein each user account is associated with a corresponding communication device;
(B) providing each user account from the plurality of user accounts with a user voiceprint managed by the remote server;
(C) establishing an audio communication session between a plurality of participant accounts with the remote server, wherein each of the participant accounts is from the plurality of user accounts;
(D) capturing a voice sample from each of the participant accounts using the corresponding communication device of each participant account, if the audio communication session is established;
(E) relaying the captured voice sample of each of the participant accounts from the corresponding communication device of each participant account to the remote server;
(F) authenticating the voice sample of each of the participant accounts based on the user voiceprint of each participant account with the remote server;
(G) generating an authenticity certificate with the remote server, if the voice sample of each of the participant accounts is authenticated;
(H) relaying the authenticity certificate from the remote server to the corresponding communication device of each of the participant accounts, if the authenticity certificate is generated; and
(I) periodically performing a plurality of iterations for steps (D) through (H), if the audio communication session remains active.

2. The method as claimed in claim 1 further comprising the steps of:
providing the plurality of participant accounts with at least one caller account and at least one recipient account;
prompting the caller account to initiate the audio communication session using the corresponding communication device of the caller account prior to step (C);
relaying a call request from the corresponding communication device of the caller account, through the remote server, and to the corresponding communication device of the recipient account, if the audio communication session is initiated;
prompting the recipient account to accept the call request using the corresponding communication device of the recipient account, if the call request is received; and
establishing the audio communication session between the caller account and the recipient account with the remote server during step (C), if the call request is accepted.

3. The method as claimed in claim 1 further comprising the steps of:
providing each user voiceprint with a plurality of baseline parameters, wherein each baseline parameter corresponds to an established acoustic feature parameter of the user voiceprint;
matching the voice sample of a specific participant account to a corresponding user voiceprint with the remote server prior to step (F), wherein the specific participant account is any of the plurality of participant accounts;
extracting a plurality of voice parameters from the voice sample of the specific participant account with the remote server, if the voice sample is matched to a corresponding user voiceprint;
comparing each voice parameter of the voice sample with a respective baseline parameter of the corresponding user voiceprint with the remote server; and
authenticating the voice sample of the specific participant account with the remote server during step (F), if each voice parameter matches the respective baseline parameter.

4. The method as claimed in claim 3 further comprising the steps of:
providing a confidence tolerance threshold managed by the remove server;
assigning a confidence score for each parameter comparison between the plurality of voice parameters of the voice sample and the plurality of baseline parameters of the corresponding user voiceprint with the remote server;
aggregating the confidence scores of the parameter comparisons for the voice sample of the specific participant with the remote server;
comparing the aggregated confidence score with the confidence tolerance threshold with the remote server; and
authenticating the voice sample of the specific participant account with the remote server, if the aggregated confidence score is greater than or equal to the confidence tolerance threshold.

5. The method as claimed in claim 1 further comprising the steps of:
generating a secure-call notification using the corresponding communication device of each participant account after step (H), if the authenticity certificate is received; and
outputting the secure-call notification using the corresponding communication device of each participant account, if the secure-call notification is generated.

6. The method as claimed in claim 1 further comprising the steps of:
generating an insecure-call notification using the corresponding communication device of each participant account after step (H), if the authenticity certificate is not received; and
outputting the insecure-call notification using the corresponding communication device of each participant account, if the insecure-call notification is generated.

7. The method as claimed in claim 1 further comprising the steps of:
prompting a user account to enter an initial voice sample using the corresponding communication device prior to step (C);
capturing the initial voice sample using the corresponding communication device, if the initial voice sample is entered;
relaying the initial voice sample from the corresponding communication device to the remote server, if the initial voice sample is captured;
extracting a plurality of initial parameters from the initial voice sample with the remote server;
generating a user voiceprint based on the initial parameters with the remote server, if the initial parameters are extracted; and
storing the user voiceprint in the user account with the remote server, if the user voiceprint is generated.

8. The method as claimed in claim 1 further comprising the steps of:
providing each user voiceprint with a plurality of baseline parameters, wherein each baseline parameter corresponds to an established acoustic feature parameter of the user voiceprint;
matching the voice sample of a specific participant account to a corresponding user voiceprint with the remote server prior to step (F), wherein the specific participant account is any of the plurality of participant accounts;
extracting a plurality of voice parameters from the voice sample of the specific participant account with the remote server, if the voice sample is matched to a corresponding user voiceprint;
comparing each voice parameter of the voice sample with a respective baseline parameter of the corresponding user voiceprint with the remote server;
identifying at least one parameter change of a specific baseline parameter from the comparison between the voice parameters and the baseline parameters with the remote server, wherein the specific baseline parameter is any of the plurality of baseline parameters of the corresponding user voiceprint; and
dynamically revising the specific baseline parameter of the corresponding user voiceprint based on the at least one parameter change with the remote server during step (F), if at least one parameter change is identified.

9. A system for verifying voice samples from participants of an audio communication session using a real-time acoustic authentication protocol, the system comprising:
at least one remote server configured to manage a plurality of user accounts, wherein each user account is associated with a corresponding communication device, and wherein each user account includes a user voiceprint;
the remote server further configured to execute computer-readable instructions to perform operations comprising:
establishing an audio communication session between a plurality of participant accounts, wherein each of the participant accounts is from the plurality of user accounts;
receiving a captured voice sample from the corresponding communication device of each participant account from the plurality of participant accounts;
authenticating the voice sample of each participant account based on the user voiceprint of the participant account;
generating an authenticity certificate;
relaying the authenticity certificate to the corresponding communication device of each of the participant accounts; and
periodically performing the authentication of the voice sample of each participant account while the audio communication session remains active.

10. The system as claimed in claim 9, wherein establishing an audio communication session between the participant accounts includes:
receiving a call request from the corresponding communication device of at least one caller account, wherein the caller account is from the plurality of participant accounts;
relaying the call request to the corresponding communication device of at least one recipient account, wherein the recipient account is from the plurality of participant accounts;
receiving a call acceptance from the corresponding communication device of the recipient account; and
establishing the audio communication session between the caller account and the recipient account.

11. The system as claimed in claim 9, wherein authenticating the voice sample of each participant account based on the user voiceprint of the participant account includes:
matching the voice sample of a specific participant account to a corresponding user voiceprint, wherein the specific participant account is any of the plurality of participant accounts;
extracting a plurality of voice parameters from the voice sample of the specific participant account;
comparing each voice parameter of the voice sample with a respective baseline parameter of the corresponding user voiceprint, wherein the respective baseline parameter is from a plurality of baseline parameters of the user voiceprint; and
authenticating the voice sample of the specific participant account based on the comparison of the voice parameters and the respective baseline parameters.

12. The system as claimed in claim 11, wherein authenticating the voice sample of each participant account based on the user voiceprint of the participant account further includes:
assigning a confidence score for each parameter comparison between the plurality of voice parameters of the voice sample and the plurality of baseline parameters of the corresponding user voiceprint;
aggregating the confidence scores of the parameter comparisons for the voice sample of the specific participant;
comparing the aggregated confidence score with a confidence tolerance threshold; and
authenticating the voice sample of the specific participant account based on the comparison between the aggregated confidence score and the confidence tolerance threshold.

13. The system as claimed in claim 9, wherein the operations further comprise:
each communication device of the plurality of participant accounts further configured to execute computer-readable instructions to perform operations comprising:
generating a secure-call notification based on the authenticity certificate; and
outputting the secure-call notification.

14. The system as claimed in claim 9, wherein the operations further comprise:
each communication device of the plurality of participant accounts further configured to execute computer-readable instructions to perform operations comprising:
generating an insecure-call notification based on the authenticity certificate; and
outputting the insecure-call notification.

15. The system as claimed in claim 9, wherein the operations further comprise:
receiving an initial voice sample from the corresponding communication device of a user account;
extracting a plurality of initial parameters from the initial voice sample;
generating a user voiceprint based on the initial parameters; and
storing the user voiceprint in the user account.

16. The system as claimed in claim 9, wherein the operations further comprise:
providing each user voiceprint with a plurality of baseline parameters, wherein each baseline parameter corresponds to an established acoustic feature parameter of the user voiceprint;
matching the voice sample of a specific participant account to a corresponding user voiceprint, wherein the specific participant account is any of the plurality of participant accounts;
extracting a plurality of voice parameters from the voice sample of the specific participant account;
comparing each voice parameter of the voice sample with a respective baseline parameter of the corresponding user voiceprint;
identifying at least one parameter change of a specific baseline parameter from the comparison between the voice parameters and the baseline parameters with the remote server, wherein the specific baseline parameter is from a plurality of baseline parameters of the user voiceprint; and
dynamically revising the specific baseline parameter of the corresponding user voiceprint based on the at least one parameter change.

17. A system and method for authenticating an audio communication session using acoustic parameter-based certificates, wherein a set of acoustic features is extracted from an audio signal from the audio communication session, wherein the set of acoustic features are transformed into a non-reversible parametric representation, and wherein the non-reversible parametric representation is used to generate a certificate for validating the integrity of the audio communication session.
